(19) United States
(12) Patent Application Publication
(10) Pub. No.: US 2005/0206641 A1
(43) Pub. Date: Sep. 22, 2005

(54) Power source circuit, display driver, and display device

(76) Inventor: Akira Morita, Nagano (JP)

Correspondence Address: HARNESS, DICKEY & PIERCE, P.L.C., P.O. BOX 828, BLOOMFIELD HILLS, MI, 48303, US

(21) Appl. No.: 11/074,339

(22) Filed: Mar. 7, 2005

(30) Foreign Application Priority Data
Mar. 18, 2004 (JP) 2004-078586

(51) Int. Cl. G09G 5/00

(52) U.S. Cl. 345/211

(57) ABSTRACT

A power source circuit includes a first regulator which outputs a first power source voltage based on a reference voltage Vref and a second regulator which outputs a power source voltage of an operation circuit of a drive circuit that drives a display panel based on the reference voltage. The first regulator outputs the first power source voltage to the drive circuit as a generating voltage for generating a drive voltage of the drive circuit. The second regulator outputs the power source voltage to the operation circuit which is coupled to a first power source line and an output of the second regulator and which forms a current path between the first power source line and the output of the second regulator during a given operation period.

### RELATED APPLICATIONS

This application claims priority to Japanese Patent Application No. 2004-078586 filed Mar. 18, 2004 which is hereby expressly incorporated by reference herein in its entirety.

### BACKGROUND

1. Technical Field

The present invention relates to a power source circuit, a display driver, and a display device.

2. Related Art

Conventionally, as a liquid crystal panel used as an electronic device (to define broadly, a display panel; more broadly, an electro-optical apparatus), it is known to utilize a passive matrix liquid crystal panel and an active matrix liquid crystal panel employing a switching element such as a thin-film transistor (hereinafter, abbreviated as TFT).

A liquid crystal driver (a display driver) for driving such a liquid crystal panel needs to have optimum driving features corresponding to features of a display of the liquid crystal panel. With regard to an issue of a variation in the display of the liquid crystal panel, the liquid crystal driver is capable of carrying out various controls such as adjusting drive voltages and drive timings. Control data of the liquid crystal driver used for these controls is pre-stored in one-time programmable read-only memory (one-time PROM or, hereinafter, OTP memory; to define broadly, nonvolatile memory) which is equipped either inside or outside the liquid crystal driver. By reading out the control data, the liquid crystal driver drives the liquid crystal panel which can then obtain the optimum display features.

However, once a memory-reading circuit for reading out the control data stored in the OTP memory starts the memory reading operation, a large current flows which causes flickering in a power source voltage of a power source line coupled to the memory-reading circuit. Flickers in the power source voltage accompanied by the memory reading operation, in particular, become the flickers in the power source voltage of the liquid crystal driver and would negatively influence on the quality of a display image of the liquid crystal panel.

Accordingly, it is desirable that the flickers in the power source voltage accompanied by the memory reading operation do not affect the quality of the display image of the liquid crystal panel. Moreover, it is desirable to suppress an increase in current consumption so as not to affect the display image quality.

In view of these issues, the present invention aims to provide a power source circuit, a display driver, and a display device to prevent deterioration of the display image due to fluctuation of the power source voltage caused by a given operation while suppressing an increase in current consumption.

### SUMMARY

In order to solve the above-mentioned problem, the present invention relates to a power source circuit for supplying a power source voltage to a drive circuit so as to drive a display panel, including: a first voltage supply circuit which is coupled to a first power source line and a second power source line and which outputs a first power source voltage based on a reference voltage; and a second power source circuit which is coupled to the first and second power source lines and which outputs the power source voltage of an operation circuit of the drive circuit based on the reference voltage, wherein: the first voltage supply circuit outputs the first power source voltage as a generating voltage for generating a voltage to drive the drive circuit to the drive circuit; and the second voltage supply circuit outputs the power source voltage to the operation circuit which is coupled to the first power source line and with the output of the second voltage supply circuit and which forms a current path between the first power source line and the output of the second voltage supply circuit during a given operation period.

With the present invention, the first power source voltage that becomes the generating voltage for generating the drive voltage of the display panel and the power source voltage of the operation circuit are separately (independently) generated based on the same reference voltage. Consequently, even when the operation circuit carries out a given operation and, during this operation, forms a current path to create a through current and thereby the power source voltage of the operation circuit fluctuates, the first power source voltage would not fluctuate. Even when the first power voltage is used as the generating voltage (the boosting voltage) of the drive voltage of the display panel, flickers in the drive voltage created due to a given operation of the operation circuit do not occur any more, whereby the deterioration of the display image can be prevented.

Further, the power source circuit of the present invention includes a diode element located between the output of the first voltage supply circuit and the output of the second voltage supply circuit, wherein the diode element may be located in a manner that a direction of the output of the first voltage supply circuit towards the output of the second voltage supply circuit is a forward direction.

According to the present invention, the diode element functions in a manner that it corrects the potential of the power source voltage of the operation circuit that is likely to decrease. Therefore, an amplitude level of signals exchanged between the operation circuit and a circuit that uses the first power source voltage as the operation power source voltage can be approximately the same, and an interface between the two circuits can be accurately produced.

Furthermore, the power source circuit according to the present invention can further include a resistor located between the output of the first voltage supply circuit and the output of the second voltage supply circuit.

According to the present invention, the amplitude level of the signals exchanged between the operation circuit and the circuit that uses the first power source voltage as the operation power source voltage can be approximately the same, and the interface between the two circuits can be accurately produced.

Also, with the power source circuit of the present invention, the second voltage supply circuit may output the power source voltage of the operation circuit during a non-drive period of the drive circuit, and the operation current of the second voltage supply circuit may be either stopped or limited during a drive period of the drive circuit.

According to the present invention, in addition to the above effect, the influence on the display image of the display panel during the drive period of the drive circuit can be reliably eliminated, since the operation circuit is limited to operating only during the non-drive period of the drive circuit. Further, since the operation of the second voltage supply circuit is stopped during the drive period of the drive circuit when the operation circuit does not operate, the current consumption can be reduced, and the overall power consumption can be lowered.

Additionally, the present invention relates to a power source circuit for supplying a power source voltage to a drive circuit so as to drive a display panel, including: a first voltage supply circuit which is coupled to a first power source line and a second power source line and which outputs a first power source voltage based on a reference voltage; and a second power source circuit which is coupled to the first and second power source lines and which outputs the power source voltage of an operation circuit of the drive circuit based on the reference voltage, wherein: the first voltage supply circuit outputs the first power source voltage as a generating voltage for generating a voltage to drive the drive circuit to the drive circuit; during the non-drive period of the drive circuit, the second voltage supply circuit outputs the power source voltage to the operation circuit which is coupled to outputs of the first and second voltage supply circuits and which forms a current path between the first power line and the output of the second voltage supply circuit during a given operation period; and during the drive period of the drive circuit, the operation current of the second voltage supply circuit is either stopped or limited.

According to the present invention, the influence on the display image of the display panel during the drive period of the drive circuit can be reliably eliminated, since the operation circuit is limited to operating only during the non-drive period of the drive circuit. Further, since the operation of the second voltage supply circuit is stopped during the drive period of the drive circuit when the operation circuit does not operate, the current consumption can be reduced, and the overall power consumption can be lowered.

In addition, with the power source circuit according to the present invention, a slew rate of the output of the first voltage supply circuit may be larger than a slew rate of the output of the second voltage supply circuit.

With the present invention, when the operation period of the drive circuit is limited, the power is supplied to the operation circuit only when necessary; therefore, the current consumption of the second voltage supply circuit can be reduced.

Further, the present invention relates to a power source circuit for supplying a power source voltage to a drive circuit so as to drive a display panel, including: a first regulator which is coupled to a first power source line and a second source line and which outputs a first power source voltage based on a reference voltage; a transistor whose source is coupled to the power source line of an operation circuit of the drive circuit and whose drain is coupled to the second power source line; and a diode element located between an output of the first regulator and the source power line of the operation circuit, wherein: the transistor is an enhancement type n-channel MOS transistor, of which gate voltage being lower than the voltage of the second power source line; the diode element is located in a manner that a direction of the output of the first regulator towards the power source line of the operation circuit is a forward direction; the first regulator outputs the first power source voltage as a generating voltage for generating a voltage to drive the drive circuit; and a drain voltage of the transistor is supplied as the power source voltage for the operation circuit which forms a current path between the first power source line and the power source line of the operation circuit during a given operation period.

With the present invention, the first power source voltage that becomes the generating voltage for generating the drive voltage of the display panel and the power source voltage of the operation circuit are separately (independently) generated based on the same reference voltage. Consequently, even when the operation circuit carries out a given operation and, during this operation, forms a current path to create a through current and thereby the power source voltage of the operation circuit fluctuates, the first power source voltage would not fluctuate. Even when the first power voltage is used as the generating voltage (the boosting voltage) of the drive voltage of the display panel, flickers in the drive voltage created due to a given operation of the operation circuit do not occur any more, whereby the deterioration of the display image can be prevented.

In addition, since the drain voltage of the transistor is supplied as the source voltage of the operation circuit, the composition can be simple, and the consumption of the current (the operation current or stand-by current) can be lower than when the power source voltage is supplied by a regulator, for example.

Also, with the power source circuit of the present invention, a gate voltage of the transistor may be fixed to be an addition of the reference voltage and a threshold voltage of the transistor.

According to the present invention, since the drain voltage of the transistor can be made the same as the reference voltage, designing of the circuit that uses the first power source voltage as the operation power source voltage and of the operation circuit can be simplified.

Furthermore, the present invention relates to a power source circuit for supplying a power source voltage to a drive circuit so as to drive a display panel, including: a first regulator which is coupled to a first power source line and a second source line and which outputs a first power source voltage based on a reference voltage; a transistor whose source is coupled to the power source line of an operation circuit of the drive circuit and whose drain is coupled to the second power source line; and a diode element located between an output of the first regulator and the source power line of the operation circuit, wherein: the diode element is located in a manner that a direction of the output of the first regulator towards the power source line of the operation circuit is a forward direction; the first regulator outputs the first power source voltage as a generating voltage for generating a voltage to drive the drive circuit during a given operation period; during a drive period of the drive circuit, the source and the drain of the transistor are electrically cut off; and, during a non-drive period of the drive circuit, the source and the drain of the transistor are electrically coupled, while a drain voltage of the transistor is supplied as the power source voltage for the operation circuit which forms a current path between the first power line and the power source line of the operation circuit during a given operation period.

With the present invention, the first power source voltage that becomes the generating voltage for generating the drive voltage of the display panel and the power source voltage of the operation circuit are separately (independently) generated based on the same reference voltage. Consequently, even when the operation circuit carries out a given operation and, during this operation, forms a current path to create a through current and thereby the power source voltage of the operation circuit fluctuates, the first power source voltage would not fluctuate. Even when the first power voltage is used as the generating voltage (the boosting voltage) of the drive voltage of the display panel, flickers in the drive voltage created due to a given operation of the operation circuit do not occur any more, whereby the deterioration of the display image can be prevented.

In addition, since the drain voltage of the transistor is supplied as the source voltage of the operation circuit, the composition can be simple, and the consumption of the current (the operation current or stand-by current) can be lower than when the power source voltage is supplied by a regulator, for example.

Additionally, with the power source circuit of the present invention, the transistor is an enhancement n-channel MOS transistor, and, during the non-drive period, a gate signal having a voltage lower than an addition of the reference voltage and a threshold voltage of the MOS transistor or a voltage lower than the voltage of the second power source voltage may be supplied to the gate.

Moreover, the power source circuit of the present invention may include a resistor located between the output of the first regulator and the power source line of the operation circuit as a substitution for the diode element.

Further, with the power source circuit of the present invention, the operation circuit may be a memory-reading circuit, the memory-reading circuit being a circuit for reading out data of nonvolatile memory which stores control data for controlling the drive circuit.

Further, the present invention relates to a display driver which includes: a data line drive circuit for driving a plurality of data lines of a display panel containing a plurality of scan lines a plurality of data lines based on gray scale data, and the power source circuit according to any of the descriptions above for outputting the first power source voltage as the generating voltage for generating the voltage to drive the display panel to the data line drive circuit as the drive circuit.

In addition, the display driver of the present invention includes a nonvolatile memory for storing control data for controlling the data line drive circuit, wherein the operation circuit may be a memory-reading circuit for reading out data of the nonvolatile memory.

Further, the display driver of the present invention may include a scan line drive circuit for scanning the plurality of scan lines.

The present invention can provide the display driver that prevents the display image from deterioration due to fluctuation of the power source voltage caused by a given operation.

Moreover, the present invention relates to a display device which includes: a plurality of scan lines, a plurality of data lines, a plurality of pixels specified by the plurality of scan lines and data lines, and the display driver according to any of the descriptions above for driving the plurality of data lines.

The present invention can provide the display device that prevents the display image from deteriorating due to fluctuation of the power source voltage caused by a given operation.

### BRIEF DESCRIPTION OF THE DRAWINGS

FIG. 1 is a diagram of an example composition of a power source circuit of a first embodiment.

FIG. 2 is a diagram showing a composition of a power source circuit of a comparative example.

FIG. 3 is a diagram showing a coupling relation of a memory-reading circuit of FIG. 2 and an OTP memory.

FIG. 4 is a diagram showing an example circuit composition of an OTP cell.

FIG. 5 is a diagram illustrating operations when a memory control circuit carries out stand-by, write, and read operations with the OPT cell.

FIG. 6 is a diagram illustrating fluctuation of a first power source voltage during the memory reading operation.

FIG. 7 is a diagram of an example composition of a power source circuit of a second embodiment.

FIG. 8 is a diagram of an example composition of a power source circuit of an alternative embodiment of the second embodiment.

FIG. 9 is a diagram of an example composition of a power source circuit of a third embodiment.

FIG. 10(A) and FIG. 10(B) are diagrams illustrating a non-drive period.

FIG. 11 is a block diagram of an example composition of a circuit for generating a non-drive period instruction.

FIG. 12 is a timing diagram of an example operation of the circuit for generating the non-drive period instruction shown in FIG. 11.

FIG. 13 is a diagram of an example composition of a power source circuit of a fourth embodiment.

FIG. 14 is a diagram of an example composition of a power source circuit of a fifth embodiment.

FIG. 15 is a block diagram of an example composition of a display device containing a data driver which employs any of the power source circuits of the present embodiments 1 through 5.

FIG. 16 is a block diagram of an example composition of the data driver shown in FIG. 15.

FIG. 17 is a block diagram of an example composition of the power source circuit shown in FIG. 16.

FIG. 18 is a block diagram of an example composition of a drive section shown in FIGS. 15 and 16.

FIG. 19 is a block diagram of an example composition of a scan driver shown in FIG. 15.

FIG. 20 is a diagram showing one example of a drive waveform of a display panel shown in FIG. 15.

FIG. 21 is a diagram illustrating a polarity inversion driving.

### DETAILED DESCRIPTION

In the following, embodiments of the present invention will be described in detail with reference to the accompanying drawings. Note that the embodiments described below do not unduly limit the content of the present invention as described in the claims. Further, not all the compositions described below are necessarily the essential configuration elements of the present invention.

1. Power Source Circuit

### 1.1 First Embodiment

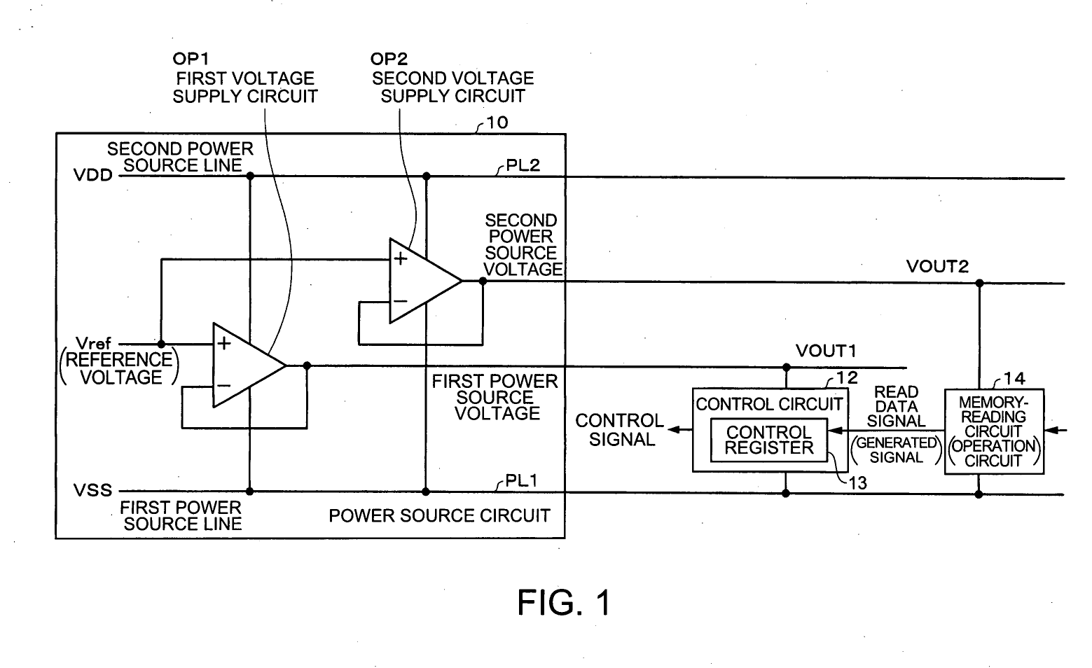

FIG. 1 shows an example composition of the power source circuit of the first embodiment.

A power source circuit 10 of the first embodiment outputs a power source voltage to a control circuit 12 and to an operation circuit. During a given operation, the operation circuit forms a path through which a through current flows. At this time, the operation circuit generates a signal in the given operation and can output the generated signal to the control circuit 12. Then, the control circuit 12 generates a specified control signal upon receiving the generated signal from the operation circuit.

An example of such an operation circuit is a memory-reading circuit 14 which reads out control data stored in a nonvolatile memory. In this situation, the control circuit 12 contains a control register 13, for example, stores the control data which was read out from the nonvolatile memory into the control register 13, and generates the control signal based on the control data stored in the control register 13.

The following will describe the situation in which the power source voltage 10 of the first embodiment is applied to the drive circuit (the display driver) that drives the display panel (the liquid crystal panel). However, it should be noted that the application of the present invention is not at all limited to the application to this type of a drive circuit. As the control circuit 12, it can be any circuit that can receive constant power supply. Further, as the operation circuit, it can be any circuit that can function as the operation circuit when power is periodically supplied.

With the drive circuit, optimum driving needs to be realized corresponding to the display features of the display panel. For this purpose, the control data is pre-stored in a memory such as the OTP memory, and the drive circuit reads out this control data. The drive circuit then drives the liquid crystal panel based on the control data so that the optimum display can be obtained. A drive circuit such as this contains the control circuit 12 which controls the drive circuit based on the control signal corresponding to the read-out control data. In order to remove a noise influence caused by the driving of the display panel, the control circuit 12 periodically carries out the read operation (the given operation) with the OTP memory and repeatedly carries out a write operation (a refresh operation) with the control data.

The power source circuit 10 of the first embodiment includes a first regulator (a first voltage supply circuit) OP1 and a second regulator (a second voltage supply circuit) OP2. Each of the first and second regulators OP1 and OP2 is composed of a voltage-follower-coupled operational amplifier.

The first regulator OP1 is coupled to a first power line PL1 and a second power line PL2 and outputs a first power source voltage VOUT1 based on a reference voltage Vref. To the first power source line PL1, a system ground power source voltage VSS is supplied. To the second power source line PL2, an external power source VDD is supplied.

The first power source voltage VOUT1 is a generating voltage for generating the drive voltage (data voltage or scan voltage) of the display panel. That is, by increasing (or decreasing) the first power source voltage VOUT1, the drive voltage of the display panel is generated. Thus, the first regulator OP1 outputs the first power source voltage VOUT1 to the drive circuit as the generating voltage to generate the drive voltage of this drive circuit.

The second power source voltage VOUT2 is coupled to the first and second power source lines PL1 and PL2 and outputs the second power source voltage VOUT2 as the power source voltage of the memory-reading circuit (operation circuit) 14 of the drive circuit based on the reference voltage Vref.

The memory-reading circuit 14 is coupled to the first power source line PL1 and the output of the second regulator OP2 and then outputs the read data signal generated (the generated signal) by carrying out the memory reading operation (the given operation) to the control circuit 12. At this time, in the memory-reading circuit 14, a current path is formed between the first power source line PL1 and the output of the second regulator OP2, allowing the through current to flow.

Further, in FIG. 1, the control circuit 12 is coupled to the first power source line PL1 and the output of the first regulator OP1. The control circuit 12 generates the control signal for controlling the drive circuit upon receiving the read data signal from the memory-reading circuit 14. More specifically, the control circuit 12 includes the control register 13 into which the control data from the OTP memory, which has been read out by the memory-reading circuit 14, is written. Then, the control circuit 12 generates the control signal based on the control data written in the control register 13.

### 1.1.1 COMPARATIVE EXAMPLE

Now, as an explanation of the effect of the power source circuit 10 of the first embodiment, a comparative example will be described in order to compare with the first embodiment.

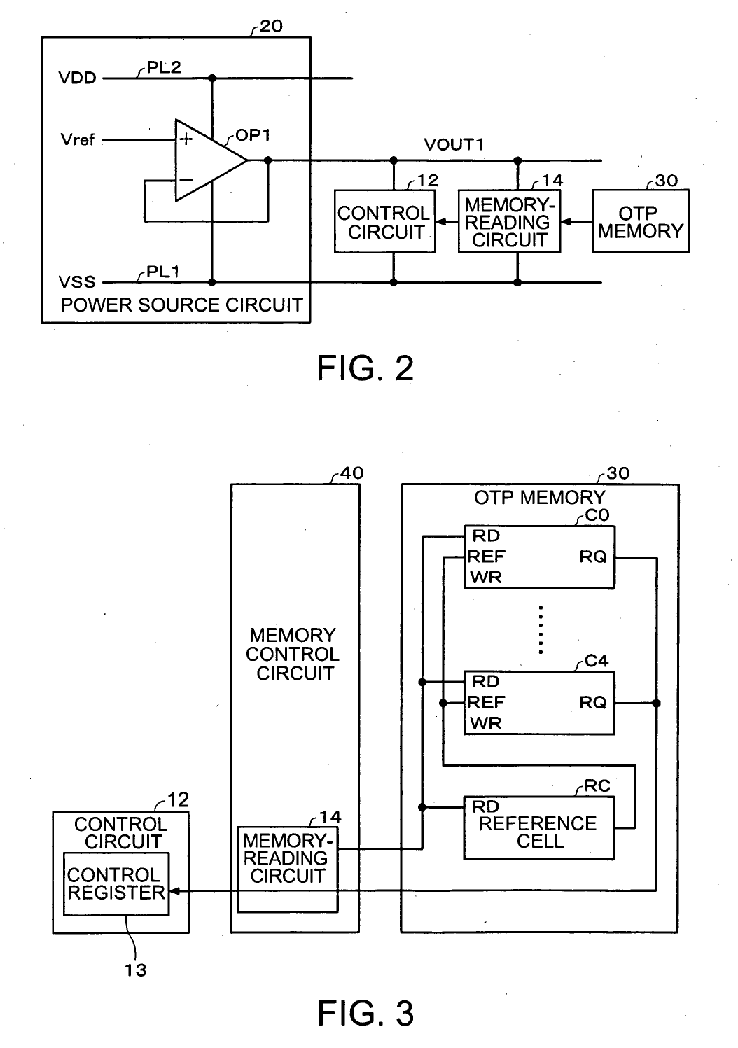

FIG. 2 shows a composition of a power source circuit of the comparative example. Note that, for the parts that are identical with FIG. 1, the same reference numbers used in FIG. 1 are used here, and descriptions thereof are omitted where appropriate.

A power source circuit 20 in the comparative example includes the first regulator OP1. The first regulator OP1 outputs the first power source voltage VOUT1 based on the reference voltage Vref. The first power source line PL1 and the output of the first regulator OP1 are coupled to the control circuit 12 and the memory-reading circuit 14. Contrary to the first embodiment, in the comparative example, the memory-reading circuit 14 operates on the output of the first regulator OP1 as the power source voltage.

1.1.2 Memory Reading Operation of OTP Memory

FIG. 3 shows a coupling relation of the memory-reading circuit 14 of FIG. 2 and an OTP memory 30.

In FIG. 3, for the convenience of description, it is assumed that the OTP memory stores 5 bit control data, and the composition thereof is simplified in the drawing. The memory-reading circuit 14 is contained in a memory control circuit 40 (not shown in FIGS. 1 and 2). The OTP memory 30 includes a plurality of OTP cells C0 to C4 and a reference cell RC. The OTP cells C0 to C4 and the reference cell RC each stores 1 bit data, each having almost the same circuit composition and layout configuration.

Upon conducting the memory reading operation, the memory-reading circuit 14 outputs a chip select signal (an enable output signal), which is not shown in the drawings, and a read control signal XREAD to the OTP memory 30. The OTP memory 30 outputs the read data signal based on the reference signal level from the reference cell RC. That is to say, in the memory reading operation of the OTP memory 30, the reference cell RC outputs the reference signal to the OTP cells C0 to C4, and these OTP cells output the read data signal based on this reference signal level. The read data signal is transmitted to the control register 13 via the memory-reading circuit 14.

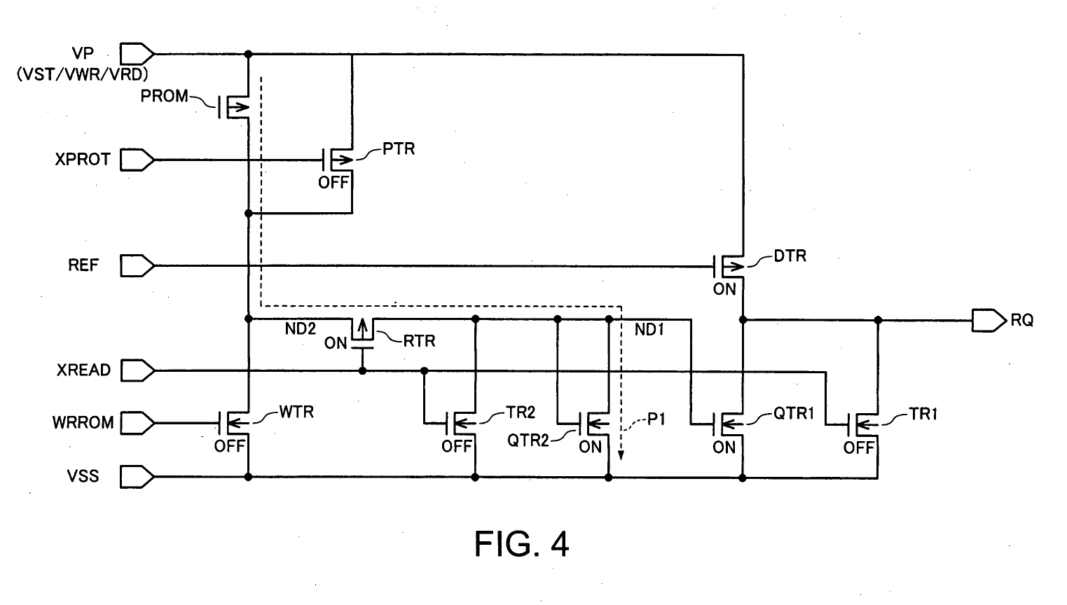

FIG. 4 shows an example composition of the OTP cell C0. Although only the OTP cell C0 is shown here, the OTP cells C1 to C4 have the same composition. Further, FIG. 4 shows an on- or off-state of each metal oxide semiconductor (MOS) transistor, that is, a state of the MOS transistor at the time of the read operation as will be described later.

In contrast to the OTP cell C0 shown in FIG. 4, an REF input is omitted from the reference cell RC, and a gate and a drain of a determination transistor DTR are therefore coupled. Since an output of the reference cell RC (RQ) becomes the REF input of the OTP cell C0, the same gate voltage is applied to the reference cell RC and to a determination transistor DTR of the OTP cell C0.

At an initial setting, the memory control circuit 40 writes the control data into the OTP memory 30. This initial setting is done during the manufacturing procedure, and, in the setting, the control data that reflects results of a characteristic test, for example, is written into the memory control circuit 40. When reading out this control data written in the OTP memory 30, the memory-reading circuit 14 outputs the read control signal XREAD to an input RD of each of the OTP cells C0 to C4. The OTP memory 30 then outputs the control data.

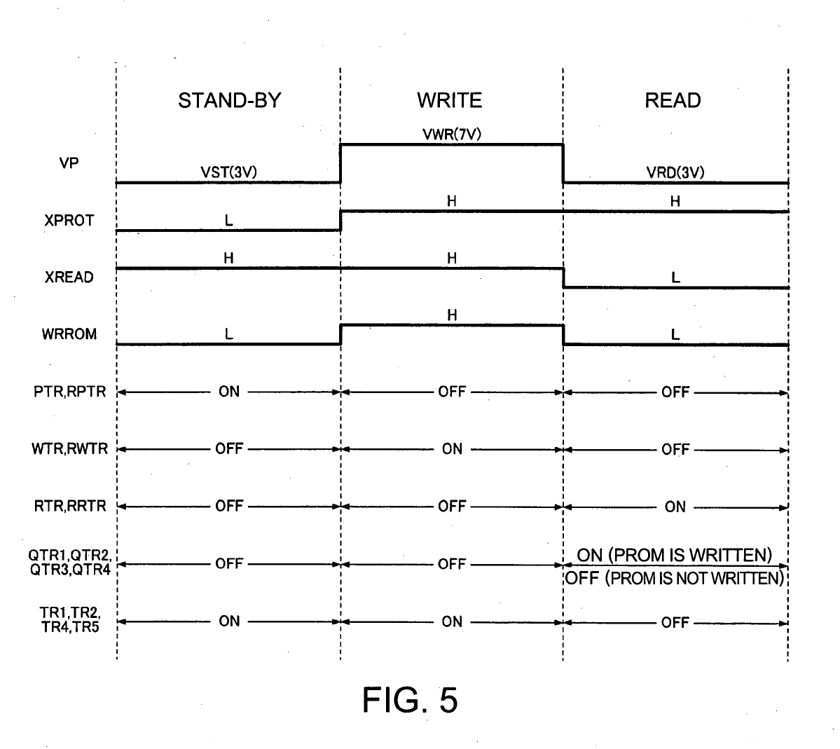

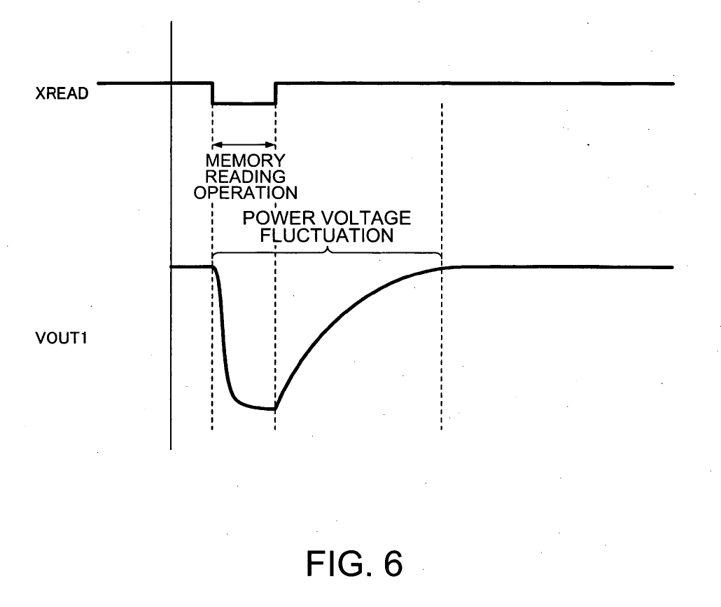

FIG. 5 shows a diagram illustrating operations of the memory control circuit 40 to carry out each stand-by, write, and read operation with the OPT cell C0. FIG. 5 shows values of the voltage VP, signal levels of a protection signal XPROT, of the read control signal XREAD, and of a write signal WRROM, and the operation state of each of the MOS transistors shown in FIG. 4.

When conducting the stand-by operation (when neither read nor write operation is conducted) with the OTP cell C0 of FIG. 4, the memory-reading circuit 40 outputs the protection signal XPROT at a low level to a gate of a protection transistor PTR as shown in FIG. 5. Therefore, as shown in FIG. 5, the protection transistor PTR turns to an on state, and the source and drain of a floating gate transistor PROM have the same potential. This prevents the charge injected into the floating gate of the floating gate transistor PROM from being pulled out.

When conducting the write operation with the OTP cell C0 in FIG. 4 at the initial setting, the memory control circuit 40 sets the voltage VP to a write voltage VWR (7V, for example). Further, the memory control circuit 40 outputs the write signal WRROM at a high level to a gate of a write transistor WTR as shown in FIG. 5. Consequently, the write transistor WTR turns to an on state as shown in FIG. 5. Thus, the voltage VWR is applied to the source of the floating gate transistor PROM, and a system ground power source voltage VSS is applied to the drain of the floating gate transistor PROM. Then, when the floating gate transistor PROM receives a high voltage (a write voltage VWR), a hot electron generated by the current that flows between the source and drain of the floating gate transistor PROM is injected into the floating gate. At this time, the state between the source and drain of the floating gate transistor PROM becomes conductive.

Then, when conducting the read operation with the OTP cell C0 shown in FIG. 4, the memory-reading circuit 14 of the memory control circuit 40 outputs the read control signal XREAD at a low level to the gate of a read transistor RTR and outputs the write signal WRROM at a low level to the gate of the write transistor WTR as shown in FIG. 5. Consequently, the read transistor RTR becomes an on state, while a transistor T1, a transistor T2, and the write transistor WTR become an off state. Further, the memory-reading circuit 14 outputs the protection signal XPROT at a high level to the protection transistor PTR.

In addition, the memory control circuit 40 (the memory-reading circuit 14) sets the voltage VP to the read voltage VRD (3V, for example). Further, the output of the reference cell RC is supplied to the gate of the determination transistor DTR. When carrying out this reading operation, the output of the reference cell RC is supplied to the OTP cell C0, since the reading operation is carried out also to the reference cell RC.

When conducting the writing operation to the floating gate transistor PROM shown in FIG. 4, the state between the source and drain of the floating gate transistor PROM becomes conductive. Therefore, the current flows to a first node ND1 and to a second node ND2 of FIG. 4. That is to say, a first output transistor QTR1 and a second output transistor QTR2 turn to an on state. Because the size of the first and second output transistors QTR1 and QTR2 is designed to be the same, they have the same capacity to supply the current. That is, because each gate of the output transistors QTR1 and QTR2 is coupled to the node ND1, an on resistance of the first output transistor QTR1 becomes as low as that of the second output transistor QTR2. Further, because the output of the reference cell is supplied to the gate of the determination transistor DTR, the determination transistor DTR becomes an on state, while, because the output voltage of the reference cell RC is set at a relatively high voltage, the current supply capacity of the determination transistor DTR becomes lower than the current supply capacity of the first output transistor QTR1. In other words, because the on resistance of the output transistor QTR1 is lower than the on resistance of the determination transistor DTR, the voltage of an output RQ of the OTP cell C0 shown in FIG. 4 will be a low level voltage (a voltage slightly higher than the system ground power source voltage VSS).

However, when the write operation is not operating at the floating gate transistor PROM of FIG. 4, the state between the source and drain of the floating gate transistor PROM becomes electrically non-conductive, and, therefore, the current does not flow to the first and second nodes ND1 and ND2. Consequently, the first and second output transistors QTR1 and QTR2 become an off state as shown in FIG. 5. Thus, the one resistance of the first output transistor QTR1 becomes sufficiently larger than the on resistance of the determination transistor DTR, and, therefore, the voltage of the output RQ of the OTP cell C0 will be a high level voltage (a voltage slightly lower than the read voltage VRD).

In the first embodiment, the reference cell RC includes the floating gate transistor PROM having the same size and same structure as that of the OTP cell C0. Therefore, the deterioration in the features of the OTP cell C0 occurs the same way as does in the features of the reference cell RC. Accordingly, reliability on the control data stored in the OTP memory 30 can be improved.

Examples of such control data are correction data of the reference voltage Vref, display characteristic parameters (e.g., gray scale information, oscillation frequency, and setting information of a PWM), and individual information of a display panel or of a drive circuit (e.g., a product number, an ID number, and a lot number). By changing the resistance division ratio of the voltage between the first and second power source lines PL1 and PL2 using the correction data of the reference voltage Vref, the level of the reference voltage Vref obtained by dividing with resistance the voltage between the first and second power source lines PL1 and PL2 can be adjusted by use of this resistance division ratio. Further, an example of the gray scale information may be a frame rate used in a frame rate control (FRC) driving method. Furthermore, an example of the setting information of the PWM would be setting information of a rising timing of a gray scale clock pulse.

Now, when conducting the read operation with the OTP cell C0, with which the write operation has been conducted, the read transistor RTR turns to an on state as shown in FIG. 4, and, because the state between the source and drain of the floating gate transistor PROM is electrically conductive, the second output transistor QTR2 turns to an on state. Thus, a current path P1 shown in FIG. 4 is formed, allowing the through current to flow.

Therefore, when the read voltage VRD (3V, for example) is shared with the first power source voltage VOUT1, the fluctuation (flickering) of the first power source voltage VOUT1 occurs. Further, because the first power source voltage VOUT1 is used as the generating voltage (the boosting voltage) of the drive voltage of the display panel, there has been a case in which the flickering of the drive voltage caused the deterioration of the display image of the display panel.

In contrast to the comparative example of the OTP memory 30 carrying out the read operation as described, the power source circuit 10 of the first embodiment shown in FIG. 1 separately (independently) generates the generating voltage for generating the drive voltage of the display panel and the power source voltage of the memory-reading circuit 14. Therefore, even if the memory-reading circuit 14 carries out the memory reading operation, the fluctuation does not occur in the first power source voltage VOUT1. Accordingly, even if the first power source voltage VOUT1 is used as the generating voltage (the boosting voltage) of the drive voltage of the display panel, the flickering caused by the memory reading operation does not occur in the drive voltage, and the deterioration of the display image can be prevented.

Additionally, it is desirable to carry out the above-described memory reading operation only during a specified period. More specifically, the memory-reading circuit (the operation circuit) 14 can carry out the memory reading operation of the drive circuit only during the non-drive period (a non-display period, or a blanking interval). In this situation, the memory-reading circuit 14 can carry out the memory reading operation periodically, thereby eliminating the influence of the fluctuation in the power source voltage caused by the memory reading operation. In the first embodiment, also, it is desirable to carry out the memory reading operation of the memory-reading circuit 14 only during the non-drive period (the non-display period, or the blanking interval), and it is effective to simplify the controls during the operation period by eliminating extra controls during the operation period.

### 1.2 Second Embodiment

The present invention is not limited to a power source circuit of the first embodiment shown in FIG. 1. In the first embodiment, the first power source voltage VOUT1 differs from the power source voltage VOUT2, and there is a case in which the control data cannot be accurately stored in the control register 13 that receives the read data signal from the memory-reading circuit 14. Thus, for the power source circuit of the second embodiment, a diode element is added to the power source circuit 10 of the first embodiment.

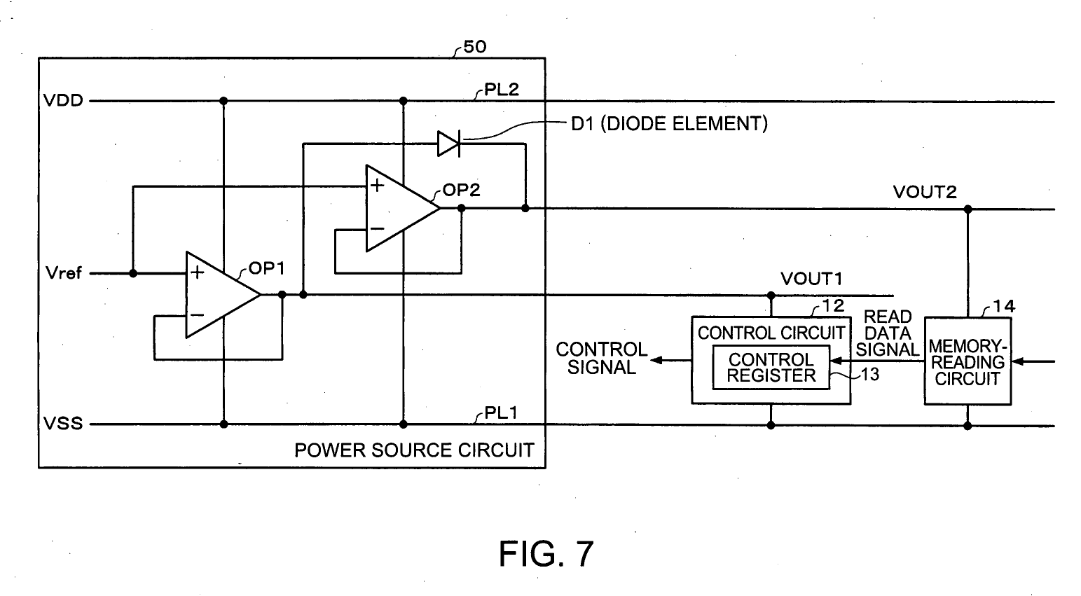

FIG. 7 shows an example composition of the power source circuit of the second embodiment. Note that the same reference numbers used in the first embodiment illustrated in FIG. 1 are used here for the parts that are identical with FIG. 1, and descriptions thereof are omitted where appropriate.

A power source circuit 50 of the second embodiment includes a diode element D1. The diode element D1 is located between the output of the first regulator OP1 and the output of the second regulator OP2. Further, the diode element D1 is located in a manner that a direction of the output of the first regulator OP1 towards the output of the second regulator OP2 is the forward direction. That is, the anode side (the positive polarity) of the diode element D1 is coupled to the output of the first regulator OP1. Also, the cathode side (the negative polarity) of the diode element D1 is coupled to the output of the second regulator OP2.

Thus, the power source voltages VOUT1 and VOUT2 output by the first and second regulators OP1 and OP2 will have approximately the same potential although there is a voltage fall in the forward direction occurring due to the diode element D1. Therefore, in FIG. 7, the level of the amplitude of the read data signal from the memory-reading circuit 14 can be almost the same as the level of the operation power source voltage of the control register 13, and, thereby, the control data corresponding to the read date signal from the memory-reading circuit 14 can be accurately written into the control register 13.

Further, since the cathode side of the diode element D1 is coupled to the output of the second regulator OP2, the potential of the second power source voltage VOUT2, which may fall, is corrected by the second regulator OP2 and the first regulator OP1 so as to maintain its potential.

Additionally, it is desirable that the slew rate of the output of the first regulator OP1 be larger than that of the output of the second regulator OP2. Here, the slew rate of the output of the regulator can indicate a rate of the change in the output voltage per hour. Therefore, if the slew rate of the output of the first regulator OP1 is larger than the slew rate of the output of the second regulator OP2, it means that the time that the first regulator OP1 uses till it reaches a specific voltage is shorter than that of the second regulator OP2.

Particularly, when the memory-reading circuit 14 coupled to the second power source voltage VOUT2 carries out the memory reading operation period only during the specified period (the non-drive period of the drive circuit), the power needs be supplied only when necessary. Therefore, by decreasing the slew rate of the output of the second regulator OP2, the power consumption of the second regulator OP2 can be reduced. In contrast, because the control circuit 12 coupled to the first power source voltage VOUT1 needs a stable and constant voltage supply, it is desirable that the first regulator OP1 have the slew rate larger that that of the output of the second regulator OP2.

In addition, the second embodiment is not limited to the composition as shown in FIG. 7. The first and second power source voltages VOUT1 and VOUT2 need only to maintain the same potential or a certain potential difference.

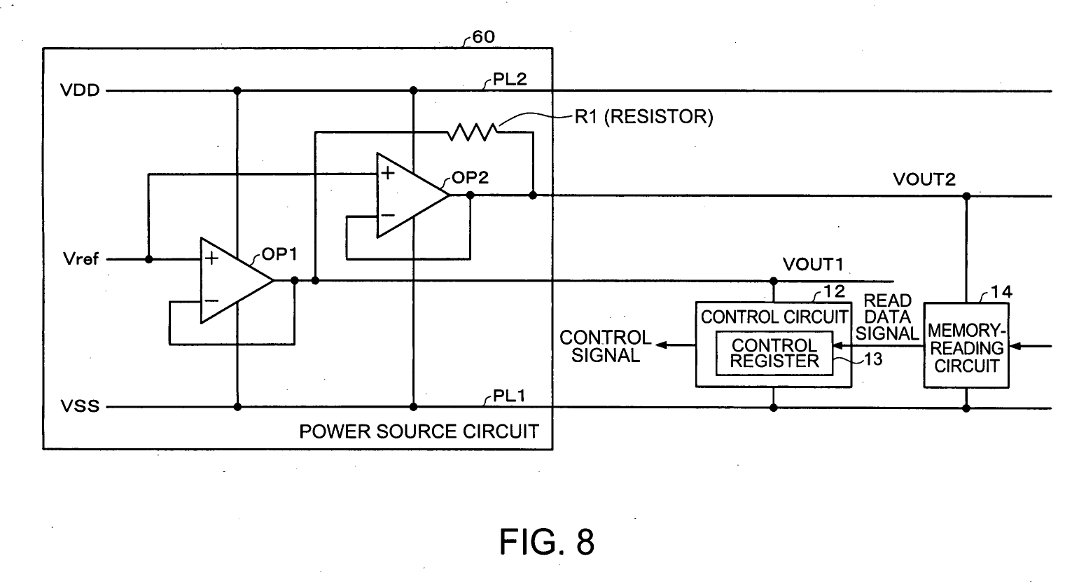

FIG. 8 shows an example composition of the power source circuit of an alternative example of the second embodiment. Note that, for the parts that are identical with the second embodiment illustrated in FIG. 7, the same reference numbers are used here, and descriptions thereof are omitted where appropriate.

A difference between a power source circuit 60 of the alternative example of the second embodiment and the power source circuit 50 of the second embodiment shown in FIG. 7 is that a resistor R1 is located in place of the diode element D1. That is, with the power source circuit 60, the resistor R1 is located between the output of the first regulator OP1 and the output of the second regulator OP2.

A resistance value of the resistor R1 is determined depending on the volume of the through current generated by the memory reading operation of the memory-reading circuit 14. Here, it is desirable that the resistance value of the resistor R1 be such that the drop range of the voltage of the second power source voltage VOUT2 does not get increased by the through current.

### 1.3 Third Embodiment

In the third embodiment, the operation of the second regulator OP2 of the second embodiment is controlled by a non-drive period instruction signal NDP1.

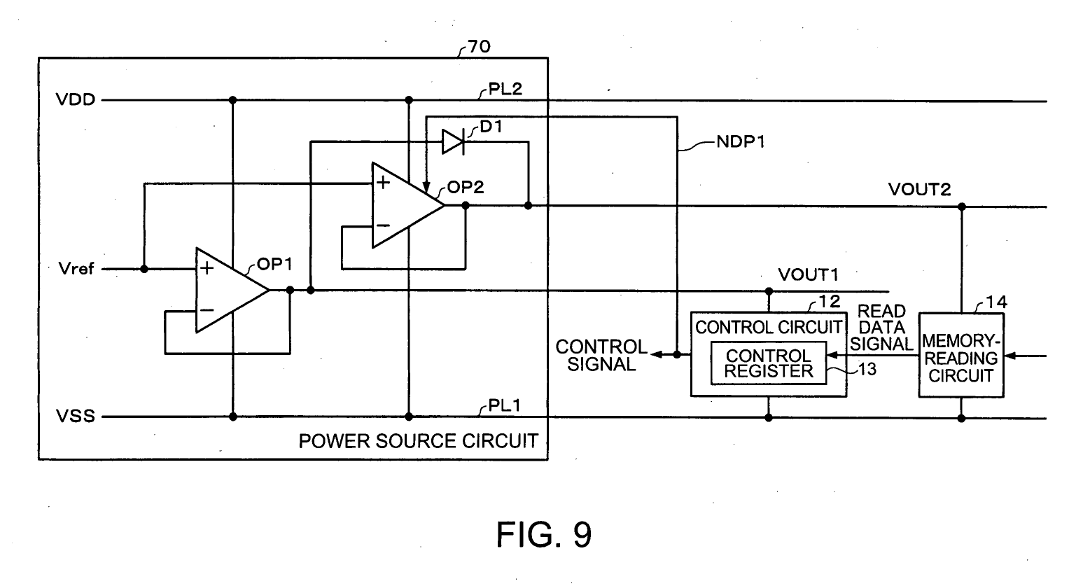

FIG. 9 shows a diagram of an example composition of the power source circuit of the third embodiment. Note that, for the parts that are identical with the second embodiment illustrated in FIG. 7, the same reference numbers are used here, and descriptions thereof are omitted where appropriate.

With a power source circuit 70 of the third embodiment, the operation current of the second regulator OP2 is controlled by the non-drive period instruction signal NDP1. The non-drive period instruction signal NDP1 becomes active during the non-drive period (the blanking interval) of the drive circuit and becomes inactive during the drive period of the drive circuit. This non-drive period instruction signal NDP1 is generated by the control circuit 12.

The operational amplifier composing the second regulator OP2 contains a current source, and when the operation current that creates this current source is either stopped or limited by the non-drive period instruction signal NDP1 that has turned inactive, the output of the second regulator OP2 is set to a high-impedance state. Thus, the second regulator OP2 stops supplying the second power source voltage VOUT2 during the drive period of the drive circuit but supplies the second power source voltage VOUT2 during the non-drive period of the same drive circuit.

Accordingly, by operating the memory-reading circuit 14 only during the non-drive period of the drive circuit, a refresh operation can be carried out, by which the control data is written into the control register 13. Because the drive circuit does not drive the display panel during the non-drive period, the memory reading operation of the memory-reading circuit 14 will not deteriorate the display image of the display panel.

Moreover, because the second regulator OP2 is operated only during the non-drive period when the memory-reading circuit 14 carries out the memory reading operation, and because the operation current of the second regulator OP2 is either stopped or limited during the drive period when the memory-reading circuit 14 does not carry out the memory reading operation, the current consumption can be greatly reduced.

Further, in FIG. 9, as in the situation with the second embodiment, the outputs of the first and second regulators OP1 and OP2 are coupled also via the diode element D1; however, this diode element D1 may be omitted. In this case, the power source circuit 70 can contain the first regulator OP1 that outputs the first power source voltage VOUT1 based on the reference voltage Vref and the second regulator OP2 that outputs the second power source voltage VOUT2, which is the power source voltage of the reading-memory-reading circuit (the operation circuit), based on the reference voltage Vref of the drive circuit. Furthermore, the first regulator OP1 can output the first power voltage VOUT1 as the generating voltage for generating the drive voltage of the drive circuit. Moreover, during the non-drive period of the drive circuit, the second regulator OP2 outputs the power source voltage to the memory-reading circuit 14, which is coupled to the first power source line PL1 and with the output of the second regulator OP2 and which forms the current path between the first power source line PL1 and the output of the second regulator OP2 during a given operation period, and, during the drive period of the drive circuit, the operation current of the second regulator OP2 can be either stopped and limited.

On the other hand, it is more desirable to provide the diode element D1 as shown in FIG. 9. This is because the power source voltage is supplied to the memory-reading circuit 14 via the diode element D1 even during the drive period, and, thereby, the memory reading operation can readily start when the period shifts to non-drive period.

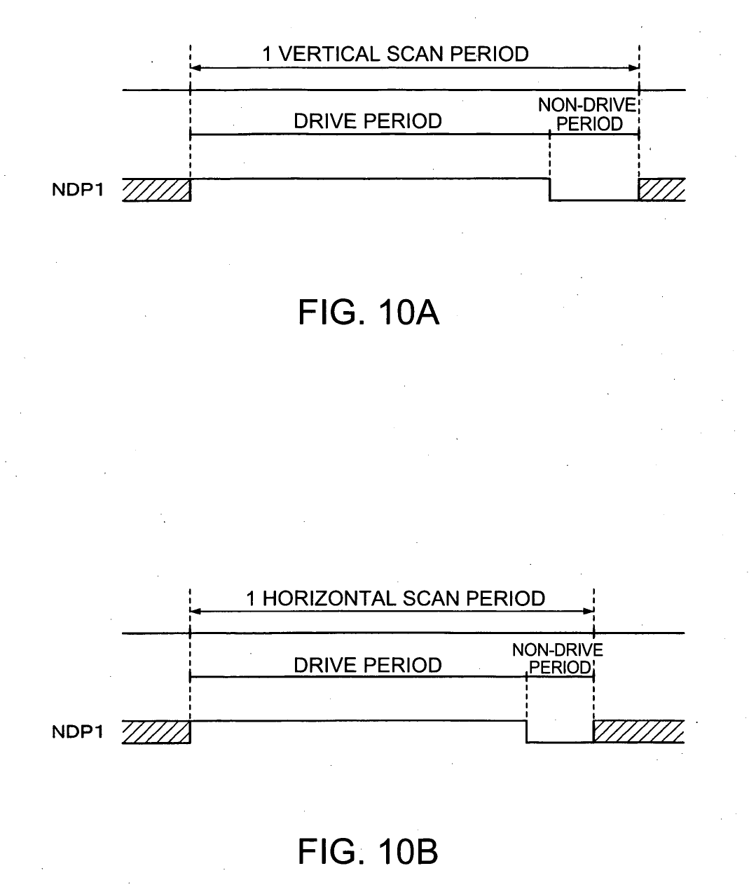

FIG. 10(A) and FIG. 10(B) are diagrams illustrating the non-drive period.

FIG. 10(A) shows a situation in that one vertical scan period includes the drive period and the non-drive period. In this situation, the non-drive period instruction signal NDP1 can be a signal that turns active during what is known as a vertical blanking interval. For example, the drive period can be a period that starts with the first horizontal scan period to the last horizontal scan period corresponding to the number of display lines during the one vertical scan period, and the non-drive period can be a period that lasts from the ending of this drive period until the beginning of the next vertical scan period.

FIG. 10(B) shows a situation in that one horizontal scan period includes the drive period and the non-drive period. In this situation, the non-drive period instruction signal NDP1 can be a signal that turns active during what is known as a horizontal blanking interval. For example, the drive period can be a given preceding period of the one horizontal scan period, and the non-drive period can be the following period that lasts from the ending of this drive period until the beginning of the next horizontal scan period.

As shown in FIG. 10(A), the following describes an example of the non-drive period instruction signal NDP1 being generated.

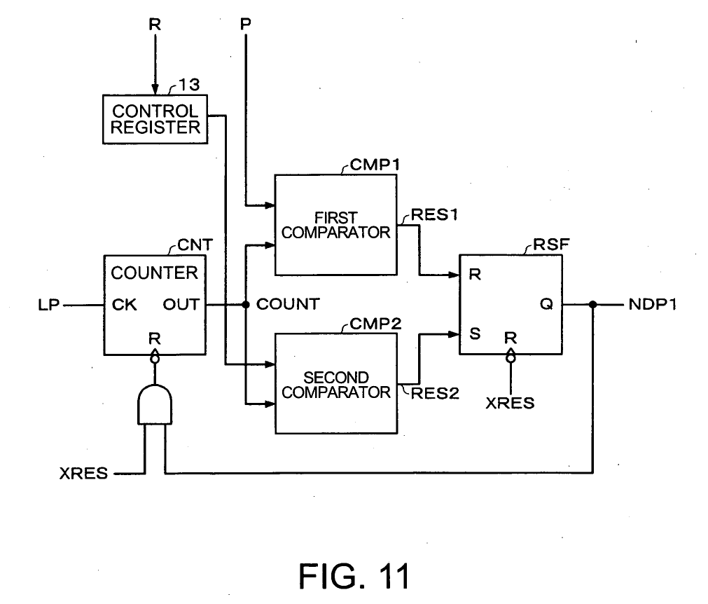

FIG. 11 shows a block diagram of an example composition of a circuit for generating the non-drive period instruction signal.

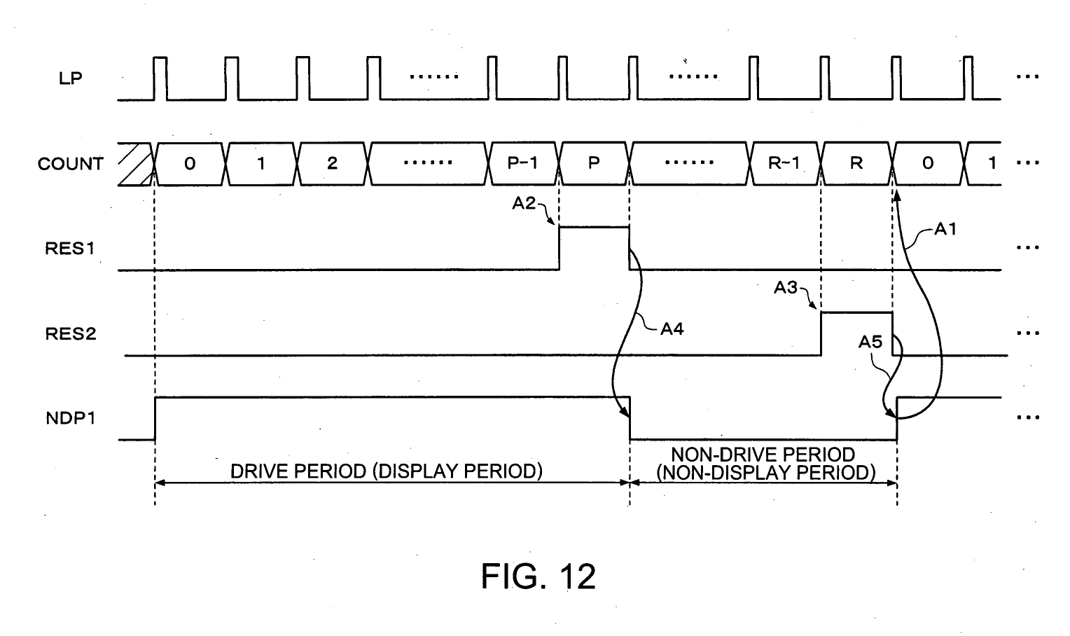

FIG. 12 shows a timing diagram of an example operation of the circuit for generating the non-drive period instruction signal of FIG. 11.

The control circuit 12 can include this circuit for generating the non-drive period instruction signal. A latch pulse LP for specifying the one horizontal scan period, a number of display panel lines R (R>0; R is an integer), and a number of display lines P (0<P≦R; P is an integer) are input into the control circuit 12. Here, one line indicates one horizontal scanning. Further, it is assumed that the number of the display panel lines R is pre-stored in the OTP memory 30. Also, it is assumed that the number of the display lines P is the control data established by a host (a display controller) that controls the drive circuit.

A counter CNT increments a count value COUNT at the rising of the latch pulse LP. The counter CNT returns the count value COUNT to the initial value at the rising of a reset input signal (A1).

A first comparator CMP1 is a magnitude comparator which carries out a match detection of the number of the display lines P and the count value COUNT. The first comparator CMP1 outputs a 1-pulse detect signal RES1 upon detecting the match between the number of the display lines P and the count value COUNT (A2).

A second comparator CMP2 is the magnitude comparator which carries out a match detection of the number of the display panel lines R and the count value COUNT. The second comparator CMP2 outputs a 1-pulse detect signal RES2 upon detecting the match between the number of the display panel lines P and the count value COUNT (A3).

A reset-set flip-flop RSF generates the non-drive period instruction signal NDP1, which is reset at the falling edge of the detect signal RES1 (A4) and is set at the falling edge of the detect signal RES2 (A5). This non-drive period instruction signal NDP1 can specify the vertical blanking interval shown in FIG. 10(A).

In the third embodiment, when thus generated and specified non-drive period instruction signal NDP1 is at a high level, the operation current of the second regulator OP2 is either limited or stopped, and when the non-drive period instruction signal NDP1 is at a low level, the second regulator OP2 operates and outputs the second power source voltage VOUT2.

In addition, the third embodiment is not limited to the composition shown in FIG. 9. As it is in the second embodiment, it is desirable that the slew rate of the output of the first regulator OP1 be larger than the slew rate of the output of the second regulator OP2. Further, what are similar to the second embodiment are that the first and second power source voltages VOUT1 and VOUT2 need only to maintain the same potential or the specified potential difference and that the resistor R1 can be located in place of the diode element D1 shown in FIG. 9.

### 1.4 Fourth Embodiment

In the fourth embodiment, a MOS transistor Q1 is provided as a substitution for the second regulator OP2 of the second embodiment shown in FIG. 7.

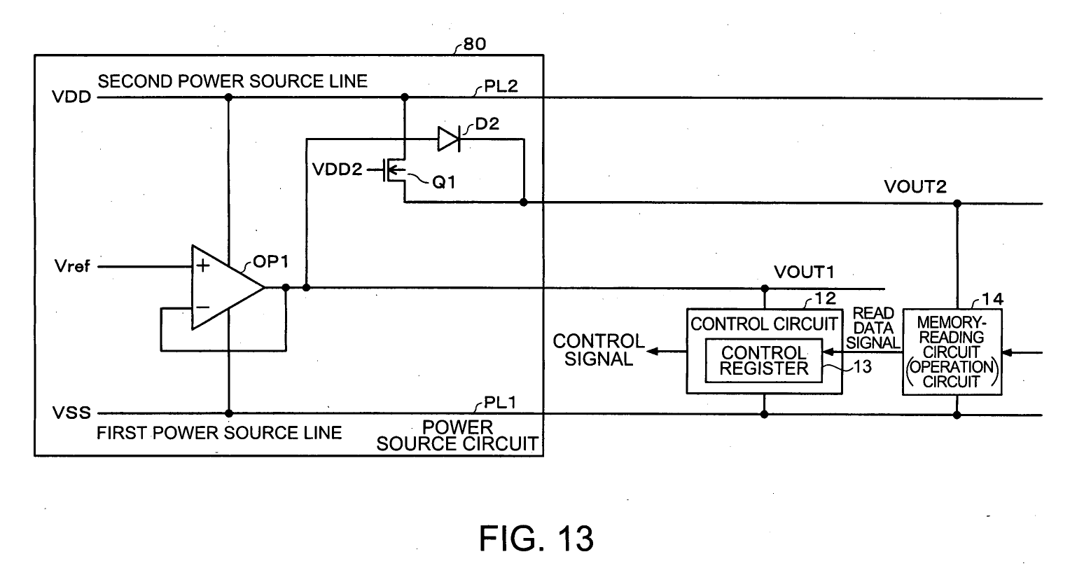

FIG. 13 shows an example composition of the power source circuit of the fourth embodiment. In FIG. 13, the same reference numbers are used for the parts that are identical with FIG. 7, and descriptions thereof are omitted where appropriate.

A power source circuit 80 in the fourth embodiment includes the first regulator OP1, the MOS transistor (to define broadly, a transistor) Q1, and a diode element D2.

The first regulator OP1 is coupled to the first and second power source lines PL1 and PL1 and then outputs the first power source voltage VOUT1 based on the reference voltage Vref. The drain of the MOS transistor Q1 is coupled to the power source line of the memory-reading circuit (the operation circuit) 14 of the drive circuit, and the source of this MOS transistor Q1 is coupled to the second power source line PL2. Then, the diode element D2 is located between the output of the first regulator OP1 and the power source line of the memory-reading circuit 14. More specifically, this diode element D1 is located so that the direction of the output of the first regulator OP1 towards the power source line of the memory-reading circuit 14 is in the forward direction.

The MOS transistor Q1 is an enhancement type n-channel MOS transistor, and a voltage VDD2 is supplied to the gate voltage of the MOS transistor Q1. This voltage VDD2 can be the voltage that is lower than the voltage of the second power source line PL2.

Then, the first regulator OP1 outputs the first power source voltage VOUT1 as the generating voltage to generate the drive voltage of the drive circuit. Further, the drain voltage of the MOS transistor Q1 is supplied to the memory-reading circuit 14 as the power source voltage (the second power source voltage VOUT2) of the memory-reading circuit 14. This memory-reading circuit 14 forms the current path between the first power source line PL1 and the power source line of the memory-reading circuit 14 during the memory reading operation.

Having such a composition, because the voltage difference between the source and the drain of the MOS transistor Q1 increases when the potential (the potential of the second power source voltage VOUT2) of the drain voltage of the MOS transistor Q1 decreases, which is caused by the memory reading operation of the memory-reading circuit 14, the MOS transistor Q1 turns to an on state. Further, the first power source voltage VOUT1 and the drain voltage (the second power source voltage VOUT2) of the MOS transistor Q1 can have approximately the same potential even though there is a voltage drop in the forward direction occurring due to the diode element D2.

Here, it is desirable that the voltage VDD2 be fixed to be an addition of the reference voltage Vref and a threshold voltage Vth of the MOS transistor Q1. In this case, when the MOS transistor Q1 turns to an on state, the second power source voltage VOUT2 can be the voltage lower than the voltage VDD2, that is, the reference voltage Vref, by the voltage equivalent to the threshold voltage Vth.

Accordingly, in the fourth embodiment, by employing the MOS transistor Q1 as a substitution for the second regulator OP2, the composition can be simplified, and the consumption of the current used by the second regulator OP2 (the operation current or the stand-by current) can be reduced.

In addition, although in the fourth embodiment the enhancement type n-channel MOS transistor was employed as the MOS transistor Q1, it is not limited thereto. Moreover, as it is possible in the alternative example of the second embodiment, it is also possible here to insert the resistor to replace with the diode element D1.

### 1.5 Fifth Embodiment

In the fifth embodiment, the MOS transistor of the fourth embodiment is controlled at the gate by the non-drive period instruction signal NDP2.

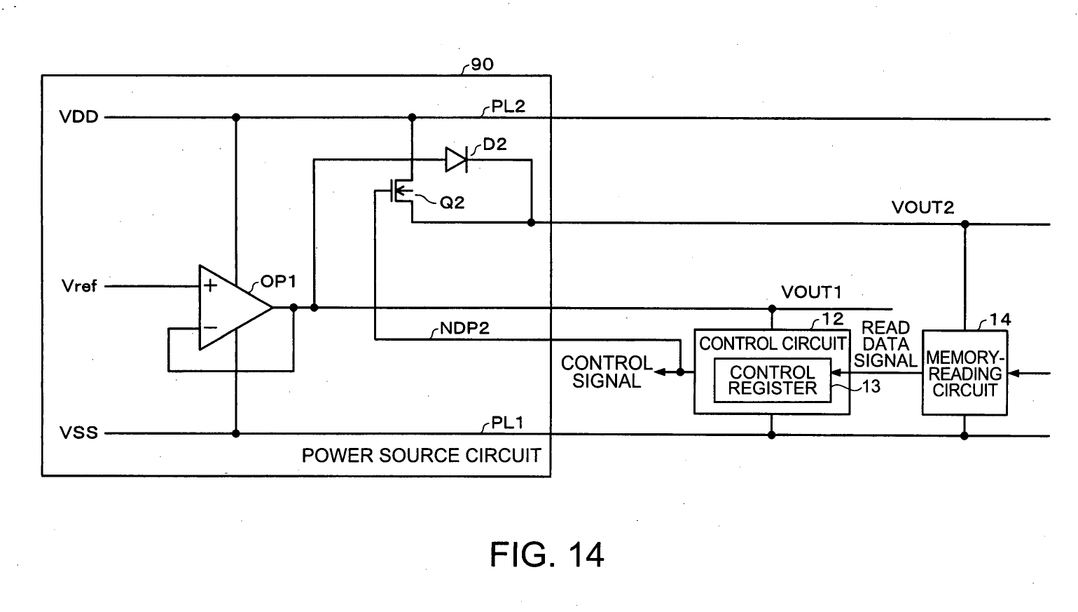

FIG. 14 shows an example composition of a power source circuit of the fifth embodiment. For the parts that are identical with the fourth embodiment, the same reference numbers are used here, and descriptions thereof are omitted where appropriate.

With a power source circuit 90 of the fifth embodiment, the MOS transistor Q2 corresponding to the MOS transistor Q1 of the fourth embodiment is controlled at the gate by the non-drive period instruction signal NDP2 coming from the control circuit 12. This non-drive period instruction signal NDP2 is a signal that shifts at the same timing as that of the non-drive period instruction signal NDP1 of the third embodiment; therefore, the description of the generation example of the non-drive period instruction signal NDP1 is omitted.

The source and the drain of the MOS transistor Q2 are electrically cut off during the drive period of the drive circuit which is designated by the non-drive period instruction signal NDP2. Further, the source and the drain of the MOS transistor Q2 are electrically coupled during the non-drive period, which is designated by the non-drive period instruction signal NDP2, of the drive circuit. Then, during this non-drive period, the memory-reading circuit (the operation circuit) 14 carries out the memory reading operation (a given operation) so as to form the current path between the first power source line PL1 and the power source line of the memory-reading circuit 14 during the operation.

Consequently, as described likewise in the third embodiment, the output of the first regulator OP1 is electrically coupled to the power source line of the memory-reading circuit 14 via the diode element D2 during the drive period, and, during the non-drive period, the MOS transistor Q2 can output the voltage, which is lower than the gate voltage by the voltage equivalent to the threshold voltage Vth, as the second power source voltage VOUT2.

Additionally, if the MOS transistor Q2 is the enhancement type n-channel MOS transistor, it is desirable to supply, to the gate of the MOS transistor Q2, the non-drive period instruction signal NDP2 of which voltage becomes lower than the addition of the reference voltage Vref and the threshold voltage Vth of this MOS transistor Q2 or than the voltage of the second power source line PL2 during the non-drive period of the drive circuit.

Further, the MOS transistor Q2 may be a depression type transistor. In this case, the drain current flows during the non-drive period of the drive circuit, and the gate of the MOS transistor Q2 receives the non-drive period instruction signal NDP2 which electrically cuts off the source and the drain of the MOS transistor Q2.

Additionally, in the fifth embodiment, also, the resistor can be located as a substitution for the diode element D2.

2. Display Device

Next, the following will describe a data driver (a display driver) which employs the above-described power source circuit and an example composition of the display device containing the data driver.

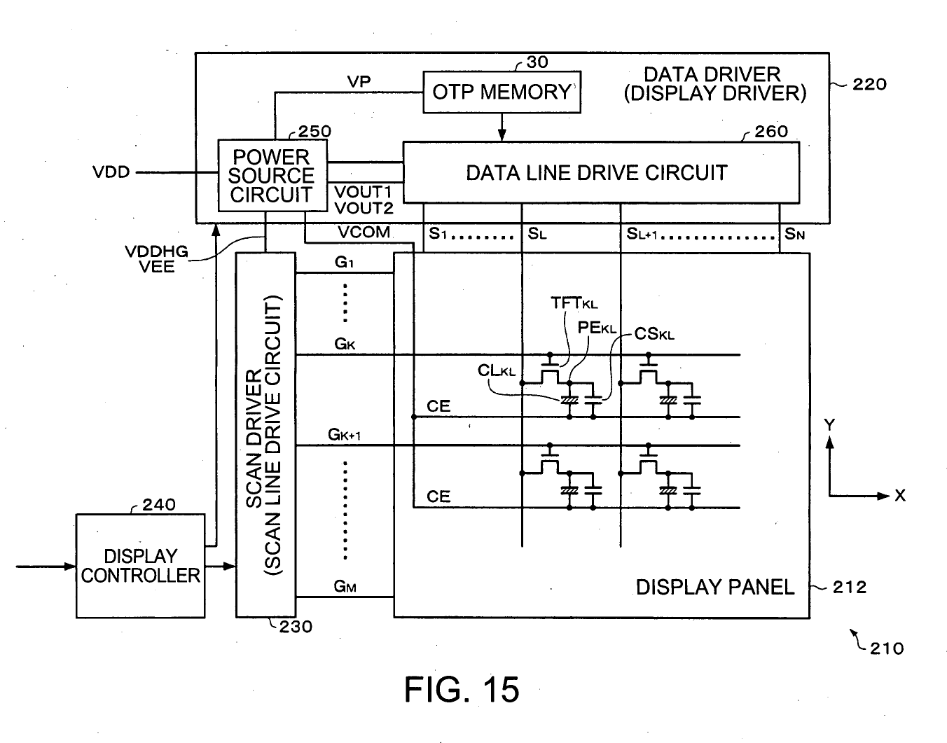

FIG. 15 shows a block diagram of an example composition of the display device containing the data driver employing the above-described power source circuit. In FIG. 15, an example composition of a liquid crystal device is shown as the display device.

This liquid crystal device (to define broadly, the display device) 210 may be incorporated in various electronic apparatuses such as mobile phones, portable information apparatuses (such as a PDA), digital cameras, projectors, portable audio players, mass storage devices, video cameras, electronic organizers, or global positioning systems (GPS's).

The liquid crystal device 210 includes a display panel 212 (narrowly, a liquid crystal display (LCD) panel), a data driver (a display driver) 220, a scan driver (a scan line drive circuit) 230, and a display controller 240. However, not all these blocks need be included in the liquid crystal device 210, and some of the circuit blocks may be omitted.

Here, the display panel 212 (broadly, an electro-optical device) includes a plurality of scan lines (narrowly, gate lines), a plurality of data lines (narrowly, source lines), and pixels (pixel electrodes) specified by the scan lines and the data lines. In this situation, the data lines are coupled to thin film transistors (TFTs; broadly, switching elements), and by coupling these TFTs with the pixel electrodes, an active matrix liquid crystal device can be composed.

More specifically, the display panel 212 is formed on an active matrix substrate (such as a glass substrate). On this active matrix substrate, scan lines G₁ to G_{M} (M is a natural number of 2 or more) arranged in a Y direction, each extending in an X direction and data lines S₁ to S_{N} (N is a natural number of 2 or more) arranged in an X direction, each extending in a Y direction. Further, the thin-film transistor TFT_{KL} (broadly, the switching element) is provided at an intersection of the scan line G_{K} (1≦K≦M; K is a natural number) and the data line SL (1≦L≦N; L is a natural number).

The gate electrode of the TFT_{KL} is coupled to the scan line G_{K}; the source electrode of the TFT_{KL} is coupled to the data line S_{L}; and the drain electrode of the TFT_{KL} is coupled to the pixel electrode PE_{KL}. Between this electrode PE_{KL} and a common electrode CE (an opposing electrode), with liquid crystal being interposed therebetween, a liquid crystal (broadly, an electro-optical substance) capacitance CL_{KL} (a liquid crystal element) and a supplementary capacitance CS_{KL} are formed. Then, the liquid crystal is filled between the active matrix substrate, on which the TFT_{KL}, the pixel electrode PE_{KL}, and the like are formed, and an opposing substrate, on which the common electrode CE is formed. Thus, permeability of the pixel is subject to change depending on the voltage applied between the pixel electrode PE_{KL} and the common electrode CE.

Additionally, a voltage level of the common voltage VCOM (a high-side voltage or a low-side voltage) supplied to the common electrode CE is generated by a common voltage generating circuit which is contained in the power source circuit of the data driver (the display driver) 220. Further, the common electrode CE does not have to be formed on the whole surface of the opposing substrate but may be formed in a form of a strip so as to correspond to each scan line.

The data driver (the display driver) 220 drives the data lines S₁ to S_{N} of the display panel 212 based on the gray scale data. On the other hand, the scan driver 230 scans (sequentially drives) the scan lines G₁ to G_{M} of the display panel 212.

The display controller 240 controls the data driver 220 and the scan driver 230 based on content established by a host such as a central processing unit (CPU), which is not shown in the drawings. More specifically, the display controller 240 supplies, to the data driver 220 and to the scan driver 230, a vertical synchronization signal or a horizontal synchronization signal generated, for example, when setting an operation mode or generated inside the display controller 240, and controls the power source circuit of the data driver 220 on a polarity inversion timing of the level voltage of the common voltage VCOM applied to the common electrode CE.

The data driver 220 includes a power source circuit 250 and a data line drive circuit (broadly, a drive circuit) 260. Further, the data driver 220 may include the above-described OTP memory 30. The power source circuit 250 can employ any of the power source circuits described in the aforementioned embodiments.

Further, the external power source voltage VDD is supplied to the power source circuit 250 although FIG. 15 omits illustrating the system ground power source line (the first power source line) that receives the system ground power source voltage VSS. The power source circuit 250 then generates the first power source voltage VOUT1 as the generating voltage of the data voltage to drive the data lines, scan voltages VDDHG and VEE to drive the scan lines, and the common voltage VCOM supplied to the common electrode CE. Further, the power source circuit 250 generates the voltages VP (VST, VRD, and VWR) used for the memory of the OTP memory 30.

The liquid crystal device 210 having such a composition drives the display panel 212 in corporation with the data driver 220 and the scan driver 230, based on the gray scale data supplied from outside under the control of the display controller 240.

In addition, although the display controller 240 is provided inside the liquid crystal device 210 in FIG. 15, it may be provided outside the liquid crystal device 210. Alternatively, the liquid crystal device 210 may include the host in addition to the display controller 240. Further, some or all of the data driver 220, the scan driver 230, and the display controller 240 may be formed on the display panel 212.

Furthermore, in FIG. 15, the display driver may be composed as a semiconductor device (an integrated circuit, or an IC) by integrating the data driver 220 and the scan driver 230. Also, this display driver may house the display controller 240.

2.1 Data Driver

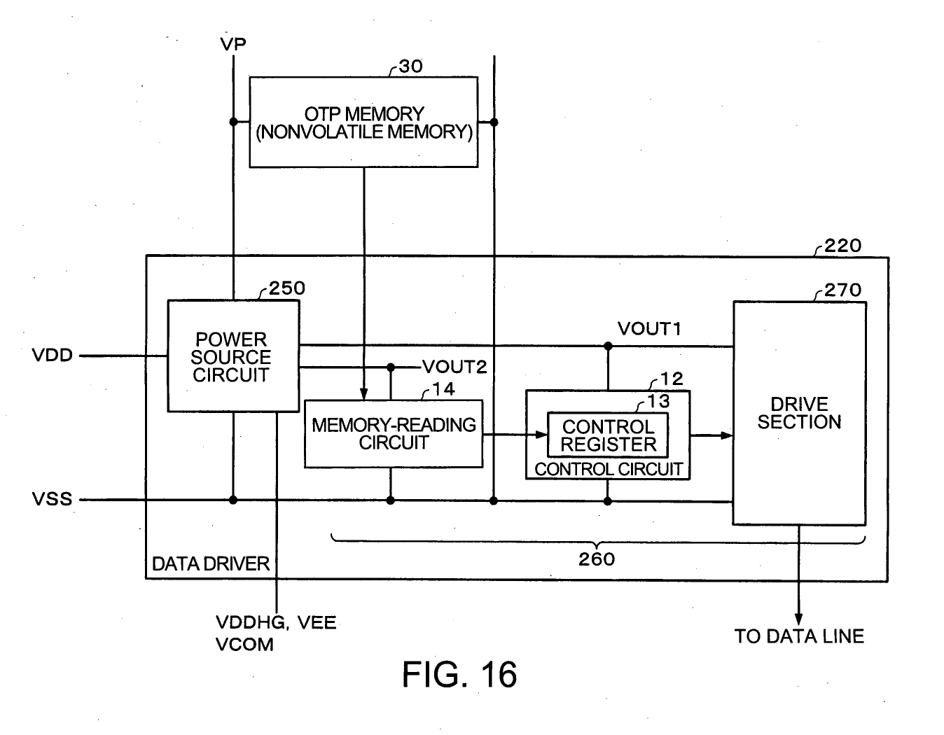

FIG. 16 shows an example composition of the data driver 220 shown in FIG. 15. For the parts that are identical with the FIGS. 1 and 15, the same reference numbers are used here, and descriptions thereof are omitted where appropriate.

Note that the OTP memory 30 may be provided either inside or outside the data driver 220. FIG. 16 shows an example composition of the OTP memory 30 as provided outside.

The data line drive circuit 260 of the data driver 220 includes the control circuit 12 (the control register 13) shown in FIG. 1, the memory-reading circuit 14, and a drive section 270. In the data line drive circuit 260, the first power source voltage VOUT1 generated by the power source circuit 250 becomes the power source voltage of the control circuit 12, and the second power source voltage VOUT2 generated by the power source circuit 250 becomes the power source voltage of the memory-reading circuit 14. Also, in the data line drive circuit 260, the first power source voltage VOUT1 is supplied as the generating voltage of the drive voltage of the data lines.

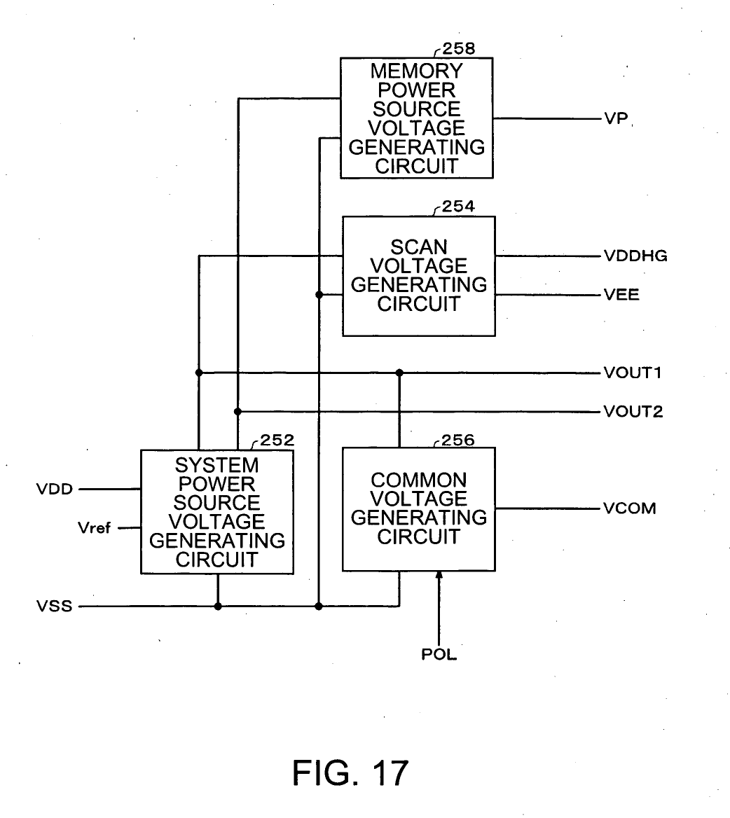

FIG. 17 shows a block diagram of an example composition of the power source circuit 250 shown in FIGS. 15 and 16.

The power source circuit 250 includes a system power source voltage generating circuit 252, a scan voltage generating circuit 254, a common voltage generating circuit 256, and a memory power voltage generating circuit 258. To this power source circuit 250, the system ground power source voltage VSS and the external power source voltage VDD are supplied.

To the system power source voltage generating circuit 252, the system ground power source voltage VSS and the external power source voltage VDD are supplied. This system power source voltage generating circuit 252 includes the power source circuit having the composition of any of the first through fifth embodiments (or of the alternative examples thereof).

To the scan voltage generating circuit 254, the system ground power source voltage VSS and the first power source voltage VOUT1 are supplied. Then, the scan voltage generating circuit 254 generates the scan voltage. The scan voltage is a voltage applied to the scan lines that are driven by the scan driver 230. Of this scan voltage, the high-side voltage is VDDHG, and the low-side voltage is VEE.

The common voltage generating circuit 256 generates the common voltage VCOM. Based on a polarity inversion signal POL, the common voltage generating circuit 256 outputs either of a high-side voltage VCOMH or a low-side voltage VCOML as the common voltage VCOM. The polarity inversion signal POL is generated by the display controller 240 while timing with the polarity inversion timing.

To the memory power source voltage generating circuit 258, the system ground power source voltage VSS and the second power source voltage VOUT2 are supplied. The memory power source voltage generating circuit 258 generates the voltages VP (VST, VRD, and VWR) used for the memory based on the voltage between the system ground power source voltage VSS and the second power source voltage VOUT2.

With the power source circuit 250 having such a composition, the fluctuation of the first power source voltage VOUT1 will be the direct cause of the fluctuation in the data voltage of the data line drive circuit and the scan voltage of the scan driver 230. However, since the second power source voltage VOUT2, which is generated separately from the first power source voltage VOUT1 as described above, is supplied to the memory-reading circuit 14 that consumes a large amount of current during the operation, the fluctuation of the first power source voltage VOUT1 can be suppressed, and the influence of the memory-reading circuit 14 during the memory reading operation can be eliminated.

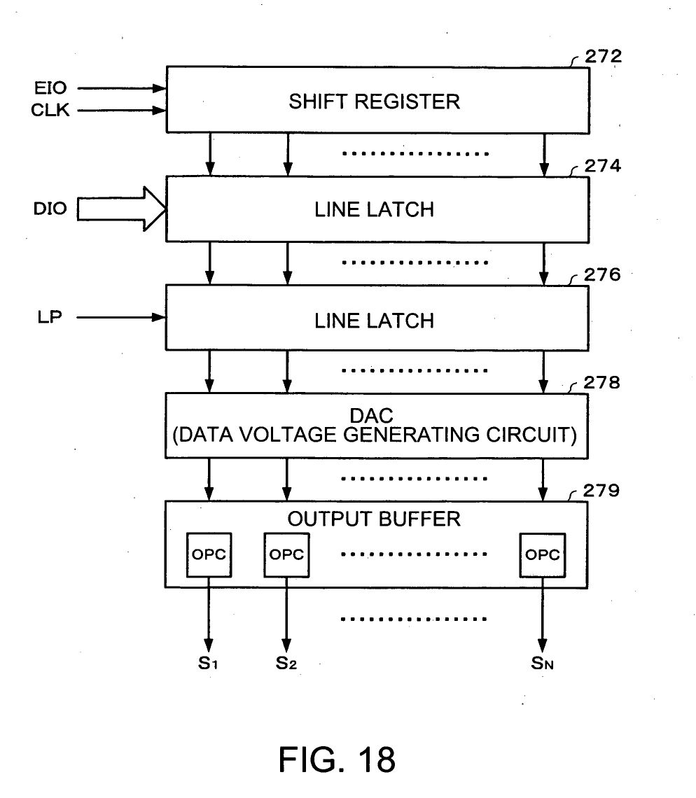

FIG. 18 shows a block diagram of an example composition of the drive section 270 shown in FIG. 16.

The drive section 270 includes a shift register 272, line latches 274 and 276, a digital-to-analog converter (DAC; to define broadly, a data voltage generating circuit), and an output buffer 279.

The shift register 272 is provided corresponding to each data line and includes a plurality of sequentially coupled flip-flops. When the shift register 272 holds an input-output enable signal EIO in synchronization with a clock signal CLK, it shifts the enable input-output signal EIO to the adjacent flip-flop in sequential synchronization with the clock signal CLK.

To the line latch 274, the display data (DIO) is input from the display controller 240 in a unit of 18 bits (6 bits (the gray scale data)×3 (colors R, G, and B)), for example. The line latch 724 latches this display data (DIO) in synchronization with the enable input-output signal EIO which was sequentially shifted by each flip-flop of the shift resister 272.

The line latch 276 latches one horizontal scan unit of the display data, which was latched by the line latch 724 in synchronization with the latch pulse LP supplied from the display controller 240.

The DAC 278 generates an analog data voltage which is to be supplied to each data line. More specifically, based on the digital gray scale data coming from the line latch 276, the DAC 278 generates the analog data voltage (the drive voltage) which corresponds to gray scale data. Even more specifically, the DAC 278 selects the voltage between the first power source voltage VOUT1 and the system ground power source voltage VSS, which comes from the system power source voltage generating circuit 252 of FIG. 17, by selecting any of the gray scale voltages based on the gray scale data depending on the number of the gray scales, and then outputs thus selected voltage as the analog data voltage that corresponds to the digital gray scale data. Therefore, if the first power source voltage VOUT1 fluctuates, it causes the fluctuation in the data voltage and influences on the display image. However, as described, the fluctuation of the first power source voltage VOUT1 can be suppressed according to the above-described embodiment.

The output buffer 279 buffers the data voltage from the DAC 278, outputs it to the data line, and drive the data line. More specifically, the output buffer 279 contains a voltage-follower-coupled operational amplifier circuit OPC provided at each data line, and each operational amplifier circuit OPC converts the impedance of the data voltage from the DAC 278 and outputs it to each data line.

2.2 Scan Line Drive Circuit

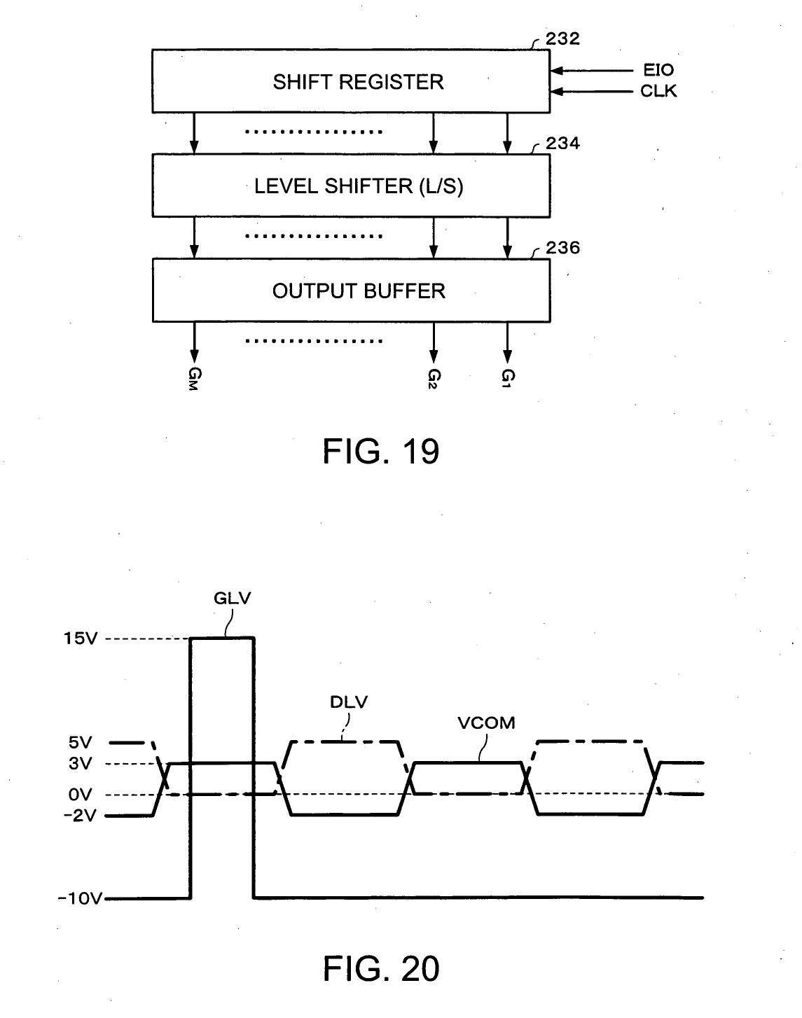

FIG. 19 shows a block diagram of an example composition of the scan driver 230 shown in FIG. 15.

The scan driver 230 includes a shift register 232, a level shifter 234, and an output buffer 236.

The shift register 232 is provided corresponding to each data line and includes a plurality of sequentially coupled flip-flops. When this shift register 232 holds the input-output enable signal EIO in synchronization with a clock signal CLK, it shifts the enable input-output signal EIO to the adjacent flip-flop in sequential synchronization with the clock signal CLK. The input-output enable signal EIO input here is the vertical synchronization signal supplied from the display controller 240.

The level shifter 234 shifts the level of the voltage from the shift register 232 to the voltage level depending on the liquid crystal element and the transistor capacity of the TFT of the display panel 212. Because the voltage level in this situation needs be as high as 20V to 50V, for example, a high-voltage process different from the processes used for other logic circuit sections is used.

The output buffer 236 buffers the scan voltage shifted by the level shifter 234, outputs it to the scan line to drive the scan line.

2.3 Operation Example of Display Device

FIG. 20 shows an example of a drive waveform of the display panel 212 shown in FIG. 15.

The gray scale voltage DLV corresponding to the gray scale date is applied to the data line. In FIG. 20, the gray scale voltage DLV of 5V amplitude is applied with reference to the system ground power source voltage VSS (=0V).

To the scan line, the scan voltage GLV having the low-side voltage VEE (=−10V) at the non-select time and the high-side voltage VDDHG (=15V) at the select time is applied.

To the common electrode CE, the common voltage VCOM having the high-side voltage VCOMH (=3V) and the low-side voltage VCOML (=−2V) is applied. Further, the polarity of the voltage level of the common voltage VCOM with reference to a given voltage is inverted as it times with the polarity inversion timing. FIG. 20 shows the waveform of the common voltage VCOM at a time of what is called a scan line inversion driving. Along with this polarity inversion timing, the polarity of the gray scale voltage DLV of the data line is also inverted based on a given voltage.

Now, it is known that the liquid crystal element has a characteristic that it deteriorates when applied with a direct current voltage for a long period of time. Thus, a driving method needs to be such that the polarity of the voltage applied to the liquid crystal element gets inverted periodically. Examples of such driving method are frame inversion driving, scan (gate) line inversion driving, data (source) line inversion driving, and dot inversion driving.

Among them, the frame inversion driving has a disadvantage in that the image is not very good even though the power consumption is low. On the other hand, the data line inversion driving and the dot inversion driving have a disadvantage in that, although the image is good, a high voltage is needed to drive the display panel.

Thus, the liquid crystal device 210 as shown in FIG. 15 employs the scan line inversion driving. With the scan line inversion driving, the polarity of the voltage applied to the liquid crystal element is inverted during every scan period (at every scan line). For example, a positive polarity voltage is applied to the liquid crystal element during the first scan period (scan line); a negative polarity voltage is applied during the second scan period; and a positive polarity voltage is applied during the third scan period. On the contrary, in the next frame, a negative polarity voltage is applied to the liquid crystal element during the first scan period (scan line); a positive polarity voltage is applied during the second scan period; and a negative polarity voltage is applied during the third scan period.

Then, in this scan line inversion driving, the polarity of the level of the common voltage VCOM of the common electrode CE converts during every scan period.

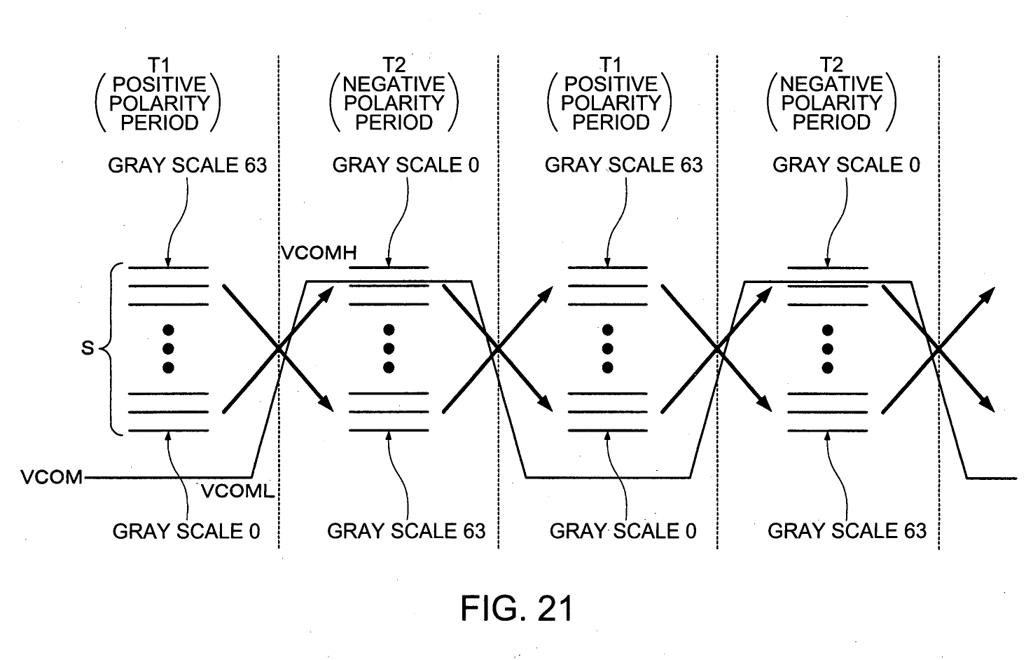

More specifically, as shown in FIG. 21, during the positive period T1 (the first period), the level of the common voltage VCOM becomes the low-side voltage VCOML, and, during the negative period T2 (the second period), the level changes to the high-side voltage VCOMH. Then, along with this timing, the polarity of the gray scale voltage applied to the data line is inverted. Note that the low-side voltage VCOML indicates the level of the voltage created by inverting the polarity of the high-side voltage VCOMH with reference to a given voltage level.

Here, the positive period T1 is the period when the voltage level of the pixel electrode that has received the gray scale voltage of the data line becomes higher than the voltage level of the common electrode CE. During this period T1, the positive polarity voltage is applied to the liquid crystal element. On the other hand, the negative period T2 is the period when the voltage level of the pixel electrode that has received the gray scale voltage of the data line becomes lower than the voltage level of the common electrode CE. During this period T2, the negative polarity voltage is applied to the liquid crystal element.

As thus shown, by inverting the polarity of the common voltage VCOM, the voltage needed to drive the display panel can be reduced. Accordingly, the maximum voltage of the drive circuit can be lowered, the manufacturing process of the drive circuit can be simplified, and the manufacturing cost can be reduced.

Additionally, the present invention is not limited to the embodiments as hereinbefore described, and there may be various alternative embodiments within the scope of the present invention. For example, the present invention may also be applied for driving an electroluminescence device and a plasma display device in addition to driving the above-described liquid crystal panel.

In the embodiments as thus described, the OTP memory was described as an example of the nonvolatile memory, but it is not limited thereto. The same is true when an erasable programmable read only memory (EPROM), an electrically erasable programmable read only memory (EEPROM), and a flash memory, for example, are used as the nonvolatile memory,

Moreover, the inventions of the dependent claims of the present invention may omit some of the aspects of the claims that these dependent claims depend on. Further, the essential elements of the invention of the independent claims of the present invention may depend on other independent claims.

1. A power source circuit for supplying a power source voltage to a drive circuit so as to drive a display panel, comprising:
a first voltage supply circuit, which is coupled to a first power source line and a second power source line, outputting a first power source voltage based on a reference voltage; and
a second power source circuit, which is coupled to the first and second power source lines, outputting the power source voltage of an operation circuit of the drive circuit based on the reference voltage, wherein:
the first voltage supply circuit outputs the first power source voltage as a voltage that generates a drive voltage for driving the drive circuit; and
the second voltage supply circuit outputs the power source voltage to the operation circuit, which is coupled to the first power source line and the output of the second voltage supply circuit, and forms a current path between the first power source line and the output of the second voltage supply circuit during a given operation period.

2. The power source circuit according to claim 1 further comprising a diode element located between the output of the first voltage supply circuit and the output of the second voltage supply circuit, wherein the diode element is located in a manner that a direction of the output of the first voltage supply circuit towards the output of the second voltage supply circuit is a forward direction.

3. The power source circuit according to claim 1 further comprising a resistor located between the output of the first voltage supply circuit and the output of the second voltage supply circuit.

4. The power source circuit according to claim 2, wherein:
during a non-drive period of the drive circuit, the second voltage supply circuit outputs the power source voltage of the operation circuit, and,
during a drive period of the drive circuit, the operation current of the second voltage supply circuit is either stopped or limited.

5. The power source circuit according to claim 2, wherein a slew rate of the output of the first voltage supply circuit is larger than a slew rate of the output of the second voltage supply circuit.

6. A power source circuit for supplying a power source voltage to a drive circuit so as to drive a display panel, comprising:
a first voltage supply circuit, which is coupled to a first power source line and a second power source line, outputting a first power source voltage based on a reference voltage; and
a second power source circuit, which is coupled to the first and second power source lines, outputting the power source voltage of an operation circuit of the drive circuit based on the reference voltage, wherein:
the first voltage supply circuit outputs the first power source voltage as a voltage to generate a voltage for driving the drive circuit;
during the non-drive period of the drive circuit, the second voltage supply circuit outputs the power source voltage to the operation circuit, which is coupled to outputs of the first and second voltage supply circuits, and forms a current path between the first power line and the output of the second voltage supply circuit during a given operation period; and
during the drive period of the drive circuit, the operation current of the second voltage supply circuit is either stopped or limited.

7. The power source circuit according to claim 6, wherein a slew rate of the output of the first voltage supply circuit is larger than a slew rate of the output of the second voltage supply circuit.

8. A power source circuit for supplying a power source voltage to a drive circuit so as to drive a display panel, comprising:
a first regulator, which is coupled to a first power source line and a second source line, outputting a first power source voltage based on a reference voltage;
a transistor whose source is coupled to the power source line of an operation circuit of the drive circuit and whose drain is coupled to the second power source line; and
a diode element located between an output of the first regulator and the source power line of the operation circuit, wherein:
the transistor is an enhancement type n-channel MOS transistor, of which gate voltage being lower than the voltage of the second power source line;
the diode element is located in a manner that a direction of the output of the first regulator towards the power source line of the operation circuit is a forward direction;
the first regulator outputs the first power source voltage as a voltage to generate a drive voltage to drive the drive circuit; and
a drain voltage of the transistor is supplied as the power source voltage for the operation circuit which forms a current path between the first power source line and the power source line of the operation circuit during a given operation period.

9. The power source circuit according to claim 8, wherein a gate voltage of the transistor is fixed to be an addition of the reference voltage and a threshold voltage of the transistor.

10. The power source circuit according to claim 8, further comprising:
a resistor located between the output of the first regulator and the power source line of the operation circuit as a substitution for the diode element.

11. The power source circuit according to claim 8, wherein:
the operation circuit is a memory-reading circuit; and
the memory-reading circuit is a circuit for reading out data of nonvolatile memory which stores control data for controlling the drive circuit.

12. A power source circuit for supplying a power source voltage to a drive circuit so as to drive a display panel, comprising:
a first regulator which is coupled to a first power source line and a second source line and which outputs a first power source voltage based on a reference voltage;
a transistor whose source is coupled to the power source line of an operation circuit of the drive circuit and whose drain is coupled to the second power source line; and
a diode element located between an output of the first regulator and the source power line of the operation circuit, wherein:
the diode element is located in a manner that a direction of the output of the first regulator towards the power source line of the operation circuit is a forward direction;
the first regulator outputs the first power source voltage as a voltage to generate a voltage for driving the drive circuit during a given operation period;
during a drive period of the drive circuit, the source and the drain of the transistor are electrically cut off; and,
during a non-drive period of the drive circuit, the source and the drain of the transistor are electrically coupled, while a drain voltage is supplied to a drain of the transistor, as the power source voltage for the operation circuit which forms a current path between the first power line and the power source line of the operation circuit, during a given operation period.

13. The power source circuit according to claim 12, wherein the transistor is an enhancement n-channel MOS transistor, and, during the non-drive period, a gate signal having a voltage lower than an addition of the reference voltage and a threshold voltage of the MOS transistor or a voltage lower than the voltage of the second power source voltage is supplied to the gate.

14. The power source circuit according to claim 12, further comprising:
a resistor located between the output of the first regulator and the power source line of the operation circuit as a substitution for the diode element.

15. The power source circuit according to claim 12, wherein:
the operation circuit is a memory-reading circuit; and
the memory-reading circuit is a circuit for reading out data of nonvolatile memory which stores control data for controlling the drive circuit.

16. A display driver comprising:
a data line drive circuit for driving a plurality of data lines of a display panel containing a plurality of scan lines a plurality of data lines based on gray scale data; and
the power source circuit according to claim 1 for outputting the first power source voltage as the generating voltage for generating the voltage to drive the display panel to the data line drive circuit as the drive circuit.

17. The display driver according to claim 16, further comprising a nonvolatile memory for storing control data for controlling the data line drive circuit, wherein the operation circuit is a memory-reading circuit for reading out data of the nonvolatile memory.

18. The display driver according to claim 16, further comprising a scan line drive circuit for scanning the plurality of scan lines.

19. The display device comprising:
a plurality of scan lines;
a plurality of data lines;
a plurality of pixels specified by the plurality of scan lines and data lines; and
the display driver according to claim 16 for driving the plurality of data lines.
